(19) United States
(12) Patent Application Publication
(10) Pub. No.: US 2022/0129879 A1
(43) Pub. Date: Apr. 28, 2022

(54) PAYMENT APPARATUS AND RECEIPT DATA CREATION METHOD

(71) Applicant: TOSHIBA TEC KABUSHIKI KAISHA, Tokyo (JP)

(72) Inventor: Yoshihiro KARITA, Fukuoka Fukuoka (JP)

(21) Appl. No.: 17/372,516

(22) Filed: Jul. 12, 2021

(30) Foreign Application Priority Data
Oct. 26, 2020 (JP) 2020-179116

(51) Int. Cl. G06Q 20/20; G07G 1/14; G07G 1/06; G07G 1/00; G07D 11/10

(52) U.S. Cl. CPC G06Q 20/209; G06Q 20/201; G07G 1/145; G06K 15/021; G07G 1/0018; G07D 11/10; G07G 1/06

(57) ABSTRACT

According to an embodiment, a payment apparatus stores, where deposit data is stored in a transaction memory, cash payment data including a cash payment amount used to pay a total amount of a deposit amount included in the deposit data, in the transaction memory. The payment apparatus creates, on the basis of information regarding a transaction stored in the transaction memory, receipt data including information regarding the total amount and the cash payment amount.

### CROSS-REFERENCE TO RELATED APPLICATIONS

This application is based upon and claims the benefit of priority from the prior Japanese Patent Application No. 2020-179116, filed on Oct. 26, 2020, the entire contents of which are incorporated herein by reference.

### FIELD

An embodiment to be described here generally relates to a payment apparatus and a receipt data creation method for a payment apparatus.

### BACKGROUND

The price of the product purchased by a consumer, the total amount, and the like as well as payment information for the total amount, i.e., the price of products, are recorded on a receipt issued to the consumer from a payment apparatus such as a POS (Point Of Sales) terminal. In this case, in the case where the consumer pays the price by a method other than cash, such as a credit card and electronic money, the amount actually paid is recorded on the receipt as payment information. Meanwhile, in the case where the consumer pays the price by cash, the deposit amount and the change amount are recorded on the receipt as payment information. For this reason, there are cases where the payment amount by cash cannot be grasped simply by glancing at the receipt.

### BRIEF DESCRIPTION OF THE DRAWINGS

FIG. 1 is a block diagram showing a configuration of a circuit of a POS terminal according to an embodiment;

FIG. 2 is a flowchart showing information processing of one transaction executed by a processor of the POS terminal according to the embodiment;

FIG. 3 is a flowchart showing non-cash payment processing executed by the processor of the POS terminal according to the embodiment;

FIG. 4 is a flowchart showing cash payment processing executed by the processor of the POS terminal according to the embodiment;

FIG. 5 is a schematic diagram showing an example of a receipt issued from the POS terminal according to the embodiment;

FIG. 6 is a schematic diagram showing an example of the receipt issued from the POS terminal according to the embodiment;

FIG. 7 is a schematic diagram showing an example of the receipt issued from the POS terminal according to the embodiment; and

FIG. 8 is a schematic diagram showing an example of the receipt issued from the POS terminal according to the embodiment.

### DETAILED DESCRIPTION

According to an embodiment, a payment apparatus includes an input device, a transaction memory, an interface, and a processor. The input device inputs information regarding a product to be purchased by a customer in a transaction. The transaction memory stores information regarding the transaction. The interface communicates with a cash handling equipment. The processor stores product sales data in the transaction memory on the basis of the input information regarding the product. The processor acquires a total amount of the transaction on the basis of the product sales data stored in the transaction memory, and stores total data including the acquired total amount in the transaction memory. The processor stores, where a deposit amount of cash from a customer is acquired via the interface, deposit data including the deposit amount in the transaction memory. The processor acquires a payment amount to be paid by the customer for the total amount, and stores payment data including the payment amount in the transaction memory. The processor acquires, where the deposit data is stored in the transaction memory, a cash payment amount used to pay the total amount, of the deposit amount included in the deposit data, and stores cash payment data including the cash payment amount in the transaction memory. The processor creates, on the basis of the information regarding the transaction stored in the transaction memory, receipt data including information regarding the total amount and the cash payment amount. Further, the processor outputs the created receipt data.

Hereinafter, an embodiment of a payment apparatus will be described with reference to the drawings. The same reference symbols in the drawings will denote the same or similar portions. This embodiment exemplifies, as a payment apparatus, a face-to-face POS terminal in which a sales clerk performs a process from sales registration of a product to be purchased by a consumer to payment of the price of the product. Note that the payment apparatus is not limited to a face-to-face POS terminal. The payment apparatus may be a self-service POS terminal in which the consumer himself/herself performs the process of sales registration of a product to payment of the price of the product. The payment apparatus may be a registration machine or an accounting machine of a semi-self-service checkout system in which sales registration of a product is performed by a sales clerk and payment of the price is performed by a consumer.

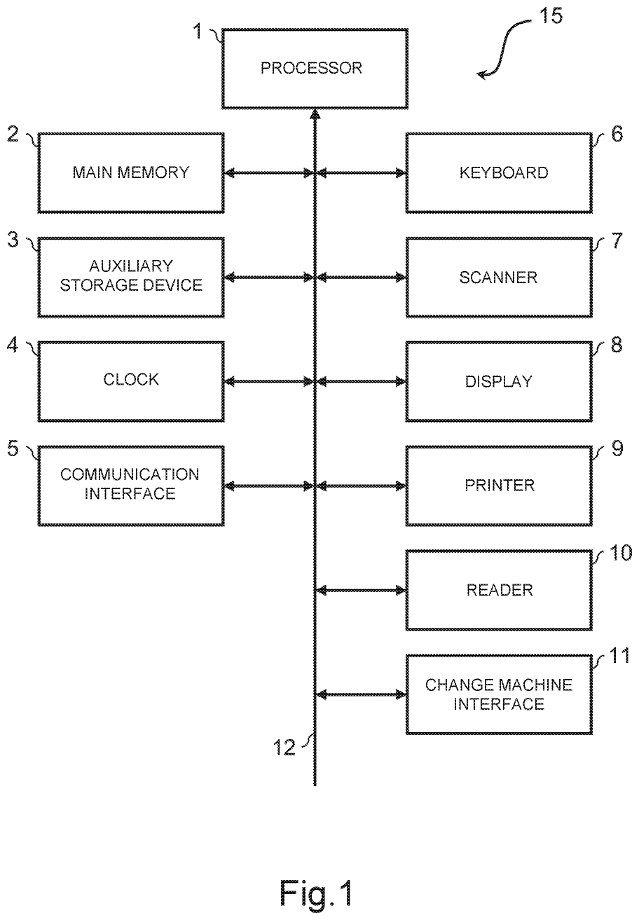

FIG. 1 is a block diagram showing a configuration of a main circuit of a POS terminal 15 according to this embodiment. The POS terminal 15 includes a processor 1, a main memory 2, an auxiliary storage device 3, a clock 4, a communication interface 5, a keyboard 6, a scanner 7, a display 8, a printer 9, a reader 10, a change machine interface 11, and a system transmission path 12. The system transmission path 12 includes an address bus, a data bus, a control signal line, and the like. The system transmission path 12 connects the processor 1, the main memory 2, the auxiliary storage device 3, the clock 4, the communication interface 5, the keyboard 6, the scanner 7, the display 8, the printer 9, the reader 10, and the change machine interface 11 to each other. When the processor 1, the main memory 2, and the auxiliary storage device 3 are connected to each other via the system transmission path 12 to constitute a computer of the POS terminal 15.

The processor 1 corresponds to the central part of the computer descried above. The processor 1 controls, in accordance with an operating system or an application program, the respective units to realize various functions as the POS terminal 15. The processor 1 is, for example, a CPU (Central Processing Unit).

The main memory 2 corresponds to the main storage section of the computer described above. The main memory 2 includes a non-volatile memory area and a volatile memory area. The memory area of the main memory 2 stores an operating system or an application program. The main memory 2 stores, in the non-volatile or volatile memory area, data necessary for the processor 1 to execute processing for controlling the respective units in some cases. The volatile memory area of the main memory 2 is used as a work area in which data is appropriately rewritten by the processor 1. In the volatile memory area of the main memory 2, for example, a transaction memory, a balance memory, a cash-payment-amount memory, and a change memory, which will be described below, are formed. The non-volatile memory area is, for example, a ROM (Read Only Memory). The volatile memory area is, for example, a RAM (Random Access Memory).

The auxiliary storage device 3 corresponds to an auxiliary storage section of the computer described above. For example, an EEPROM (Electric Erasable Programmable Read-Only Memory), an HDD (Hard Disk Drive), an SSD (Solid State Drive), or the like can be used as the auxiliary storage device 3. The auxiliary storage device 3 stores data used by the processor 1 to perform various types of processing, data created by the processing in the processor 1, and the like. The auxiliary storage device 3 stores the application program described above in some cases.

The application program stored in the main memory 2 or the auxiliary storage device 3 includes a control program in which information processing executed by the POS terminal 15 is described. The method of installing the control program in the main memory 2 or the auxiliary storage device 3 is not particularly limited. The control program may be installed in the main memory 2 or the auxiliary storage device 3 by being recorded on a removable recording medium or distributed through communication via a network. The recording medium may have any form such as a CD-ROM and a memory card, as long as the recording medium is capable of storing a program and can be read by an apparatus.

The clock 4 functions as a time information source of the POS terminal 15. The processor 1 acquires the present date and time on the basis of the time information clocked by the clock 4.

The communication interface 5 performs data communication via a network such as a wired LAN (Local Area Network) and a wireless LAN. A store server, a credit card server, an electronic money server, and the like are connected to the network. The store server centrally manages operations of a plurality of POS terminals 15 installed in one store. The credit server supports payment by a credit card. The electronic money server supports payment by electronic money.

The keyboard 6 is an input device of the POS terminal 15. The keyboard 6 is a keyboard dedicated for the POS terminal 15 in which various function keys such as a multiplication key, a subtotal key, and a closing key are disposed in addition to a numeric key for inputting a numerical value such as the number and the amount. The closing key instructs the end of the registration of the product(s) sold as one transaction. The keyboard 6 may be one obtained by assigning a function required by the POS terminal 15 to an arbitrary key of a general-purpose keyboard.

The scanner 7 is an input device of the POS terminal 15. The scanner 7 reads a code symbol such as a bar code and a two-dimensional code. The scanner 7 may be of a type that reads a code symbol by scanning with a laser beam, or may be of a type that reads a code symbol from an image captured by an imaging device. Further, the scanner 7 may be a handy scanner or a stationary scanner.

The display 8 is a display device of the POS terminal 15. The display 8 includes a first display for displaying image information to a sales clerk who is an operator, and a second display for displaying image information to a consumer who is a customer. As this type of display 8, for example, a liquid crystal display, an organic EL (Electroluminescence) display, or the like can be used. The display 8 may be a touch panel.

The printer 9 is a printing device of the POS terminal 15. The printer 9 prints information on a receipt paper to issue a receipt. As this type of printer 9, for example, a thermal printer, a dot-impact printer, or the like can be used.

The reader 10 is an input device of the POS terminal 15. The reader 10 reads data recorded on a recording medium such as a credit card and electronic money. In the case where the recording medium is an IC card, the reader 10 is an IC card reader. In the case where the recording medium is an RFID (Radio Frequency Identification) tag, the reader 10 is an RFID reader. The reader 10 is not limited to one type. The POS terminal 15 may include a plurality of types of readers 10.

The change machine interface 11 performs data communication with an automatic change machine of a cash handling equipment. The change machine interface 11 receives data of the input amount, data of the number of stored coins and bills, and the like from the automatic change machine. The change machine interface 11 transmits the change data to the automatic change machine. The automatic change machine automatically pays out the cash corresponding to the change in accordance with the change data.

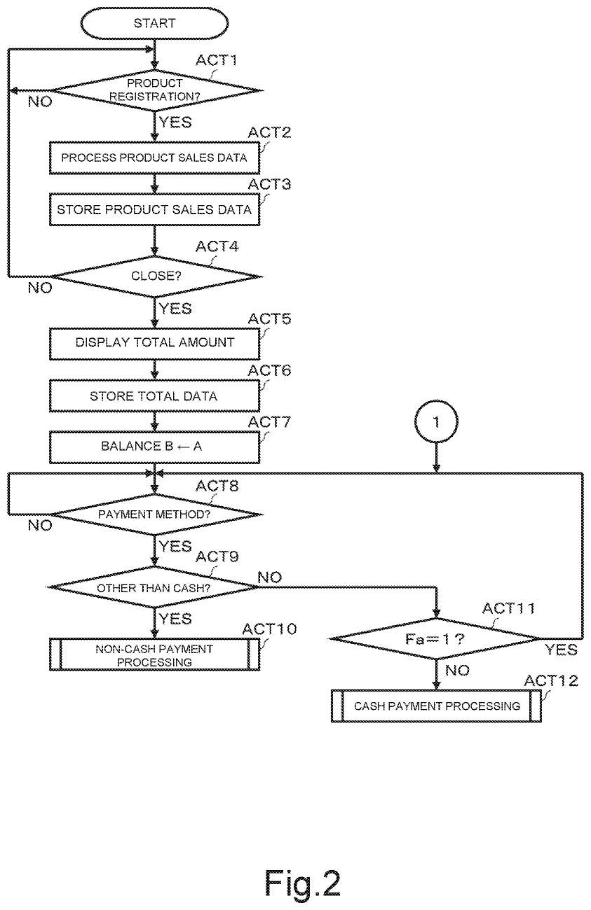

FIG. 2 to FIG. 4 are each a flowchart showing information processing in one transaction executed by the processor 1 in accordance with a control program. The main operation of the POS terminal 15 will be described below with reference to FIG. 2 to FIG. 4. Note that the content of the operation described below is an example. The processing procedure and the like are not particularly limited as long as the same result can be achieved.

The sales clerk who is the operator of the POS terminal 15 checks whether or not a bar code is attached to a product to be purchased by a consumer who is a customer, i.e., a product to be purchased. The barcode is one obtained by bar-coding a product code unique to a product. In the case where a bar code is attached to a product to be purchased, the sales clerk operates the scanner 7 and causes the scanner 7 to read the bar code. In the case where no bar code is attached to the product, the sales clerk operates the keyboard 6 and inputs the product code of the product to be purchased.

In ACT1, the processor 1 stands by for product registration by determining whether or not a product to be purchased, which is sold as one transaction, has been registered. Specifically, the processor 1 determines whether or not a product to be purchased has been registered by determining whether or not the product code has been input via the keyboard 6 or the scanner 7. When whether or not a product code has been input via the keyboard 6 or the scanner 7 is determined and thus it is determined that the product to be purchased has been registered (YES in ACT1), the processing of the processor 1 proceeds to ACT2.

In ACT2, the processor 1 processes product sales data. That is, the processor 1 acquires product data of the product specified by the input product code described above. For example, the auxiliary storage device 3 stores a product data file storing product data such as product names and prices in association with the product codes of the respective products. The processor 1 searches the product data file and acquires the product data associated with the input product code described above. The processor 1 multiplies the price included in the product data by the number of sales to calculate the sales amount. The number of sales represents a multiplier in the case where the multiplier is input by the numeric key and the multiplication key before the product code is input. In the case where no multiplier is input, the number of sales is “1”. The processor 1 displays, on the display 8, the product name, the price, the number of sales, the sales amount, and the like.

In ACT3, the processor 1 stores the product sales data. That is, the processor 1 writes product sales data including a product code, a product name, a price, the number of sales, the sales amount, and the like in the transaction memory. The transaction memory is formed in a volatile region of the main memory 2.

In ACT4, the processor 1 determines whether or not the closing key of the keyboard 6 has been operated. In the case where it is determined that the closing key has not been operated (No in ACT4), the processing of the processor 1 returns to ACT1. In ACT1, the processor 1 stands by for the next product registration.

The sales clerk inputs a product code of a product to be purchased to the POS terminal 15 by operating the keyboard 6 or the scanner 7. When the product codes of all the products to be purchased have been input, the sales clerk operates the closing key.

The processor 1 executes the above-mentioned processing of ACT2 and ACT3 each time the registration of a product to be purchased has been determined. Meanwhile, in the case where it is determined in ACT4 that the closing key has been operated by the signal from the keyboard 6 (YES in ACT4), the processing of the processor 1 proceeds to ACT5. In ACT5, the processor 1 displays, on the display 8, the total amount “A” in one transaction. That is, the processor 1 calculates the total amount “A” in one transaction by summing up the sales amount of the products (product price on the receipt) of the sales data stored in the transaction memory (main memory 2) and adding the tax amount thereto as necessary. The processor 1 then displays the total amount “A” on the display 8.

In ACT6, the processor 1 stores the total data. That is, the processor 1 writes the total data including the total amount, the total number of sales, and the like to the transaction memory (main memory 2). The total number of sales represents a value obtained by summing up the number of sales of the product sales data stored in the transaction memory. In ACTT, the processor 1 writes the total amount “A” to the balance memory. That is, the processor 1 rewrites the balance “B” of the balance memory (value stored in the balance memory) to the total amount “A”. The balance memory is formed in a volatile region of the main memory 2.

The sales clerk who has operated and input the closing key receives payment of the price from the consumer. The consumer pays the total amount “A” displayed on the display 8 by a payment method such as cash, a credit card, electronic money, and a gift certificate. At this time, the consumer may select one of the payment methods to pay the price, or may pay the price by two or more types of payment methods.

In the case where the consumer pays the price by cash, the sales clerk puts the cash in the automated change machine. In the case where the consumer pays the price by a credit card, the sales clerk causes the reader 10 to read the data of the credit card. In the case where the consumer pays the price by electronic money, the sales clerk causes the reader to read the data relating to the electronic money. Alternatively, the sales clerk causes the scanner 7 to read the data relating to the electronic money.

In ACT8, the processor 1 stands by for selection of a payment method by determining whether or not a payment method has been selected. For example, in the case where cash is put in the automatic change machine, the processor 1 determines that cash has been selected as the payment method. For example, in the case where data of a credit card is read by the reader 10, the processor 1 determines that a credit card has been selected as the payment method. For example, in the case where data relating to electronic money is read by the reader 10 or the scanner 7, the processor 1 determines that electronic money has been selected as the payment method.

For example, in the case where a bar code printed on a gift certificate is read by the scanner 7, the processor 1 determines that a gift certificate has been selected as the payment method.

When it is determined that one of the above-mentioned payment methods has been selected (YES in ACT8), the processing of the processor 1 proceeds to ACT9. In ACT9, the processor 1 determines whether or not a payment method other than cash has been selected. In the case where it is determined that a payment method other than cash, i.e., a payment method such as a credit card, electronic money, and a gift certificate has been selected (YES in ACT9), the processing of the processor 1 proceeds to ACT10. In ACT10, the processor 1 executes non-cash payment processing. Details of the non-cash payment processing will be described below.

Meanwhile, in the case where it is determined in ACT9 that cash has been selected as the payment method (NO in ACT9), the processing of the processor 1 proceeds to ACT11. In ACT11, the processor 1 determines whether or not a flag Fa is set to “1”. The flag Fa has been reset to “0” in the initial state, and is 1-bit data to be set to “1” in the cash payment processing described below. In the case where it is determined that the flag Fa is not set to “1”, i.e., the flag Fa is reset to “0” (NO in ACT11), the processing of the processor 1 proceeds to ACT12. In ACT12, the processor 1 executes cash payment processing. Details of the cash payment processing will be described below.

Meanwhile, in the case where it is determined in ACT11 that the flag Fa is reset to “1” (YES in ACT11), the processing of the processor 1 returns to ACT8. As described above, the processor 1 does not execute the cash payment processing (processing of ACT11) while the flag Fa is set to “1”, i.e., in the case where cash is selected again as the payment method after the cash payment processing is executed. The processor 1 stands by for the payment of the price by a payment method other than cash.

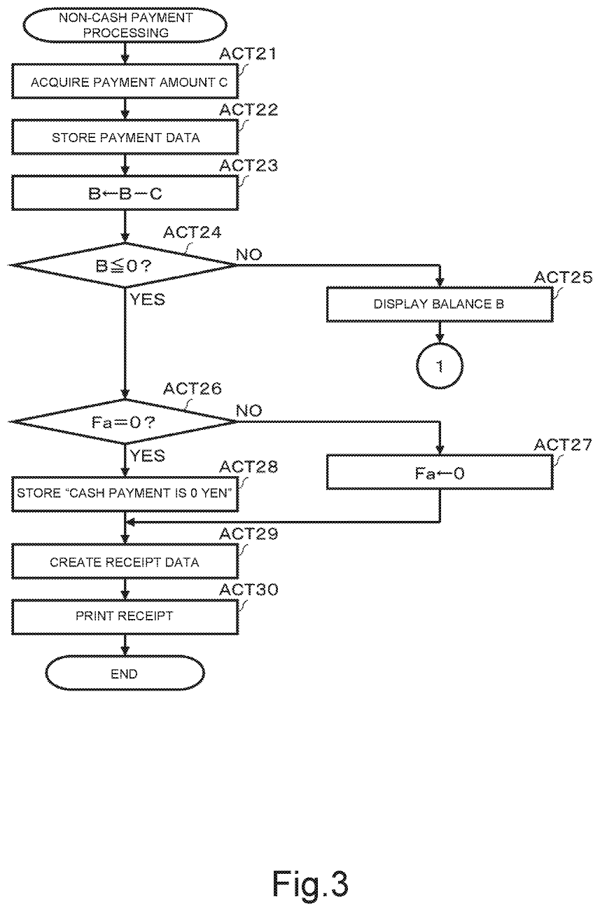

FIG. 3 is a flowchart showing the non-cash payment processing executed by the processor 1. When starting the non-cash payment processing, the processor 1 acquires a payment amount “C” in ACT21. The payment amount “C” is an amount to be paid by the customer for the total amount “A”, and the processor 1 acquires the payment amount “C” on the basis of the total amount “A”. That is, the payment amount “C” in this case is the same amount as the total amount “A”. Further, in the case of credit card payment, the payment amount “C” is the amount paid by a credit card. In the case of electronic money payment, the payment amount “C” is the amount paid by electronic money. In the case of gift certificate payment, the payment amount “C” is the face value of the gift certificate.

When acquiring the payment amount “C”, the processor 1 stores the payment data in ACT22. That is, the processor 1 writes the payment data including the name code and the payment amount “C” to the transaction memory (main memory 2). The name code is a unique code set for each name that indicates the payment method. In advance, a name and a name code are set for each payment method such as cash, a credit card, electronic money, and a gift certificate.

In ACT23, the processor 1 subtracts the payment amount “C” from the balance “B” of the balance memory (main memory 2). The processor 1 then determines whether or not the balance “B” is 0 yen or less, i.e., the balance “B” runs out in ACT24. The balance “B” (the value stored in the balance memory) in this case is the total amount “A” (see ACTT). In the case where it is determined that the balance B is larger than 0 yen (NO in ACT24), the payment of the price has not been completed. In the case where it is determined that the balance B is larger than 0 yen, the processing of the processor 1 proceeds to ACT25. In ACT25, the processor 1 displays the balance B on the display 8. That is, an amount obtained by subtracting the payment amount “C” from the total amount “A” is displayed on the display 8. The processing of the processor 1 then returns to ACT8 in FIG. 2. That is, the processor 1 stands by for a payment method to be selected. When a payment method is selected, the processor 1 executes the processing of ACT9 in FIG. 2 and subsequent ACTs as described above.

Meanwhile, in the case where it is determined in ACT24 that the balance “B” is 0 yen or less (YES in ACT24), the processing of the processor 1 proceeds to ACT26. In ACT26, the processor 1 determines whether or not the flag Fa is reset to “0”.

In the case where it is determined that the flag Fa is set to “1” (NO in ACT26), the processing of the processor 1 proceeds to ACT27. In ACT27, the processor 1 resets the flag Fa to “0”.

Meanwhile, in the case where it is determined in ACT26 that the flag Fa is reset to “0” (YES in ACT26), the processing of the processor 1 proceeds to ACT28. In ACT28, the processor 1 stores text data indicating that the cash payment is 0 yen. That is, the processor 1 writes the text data indicating that, for example, “cash payment is 0 yen” to the transaction memory (main memory 2).

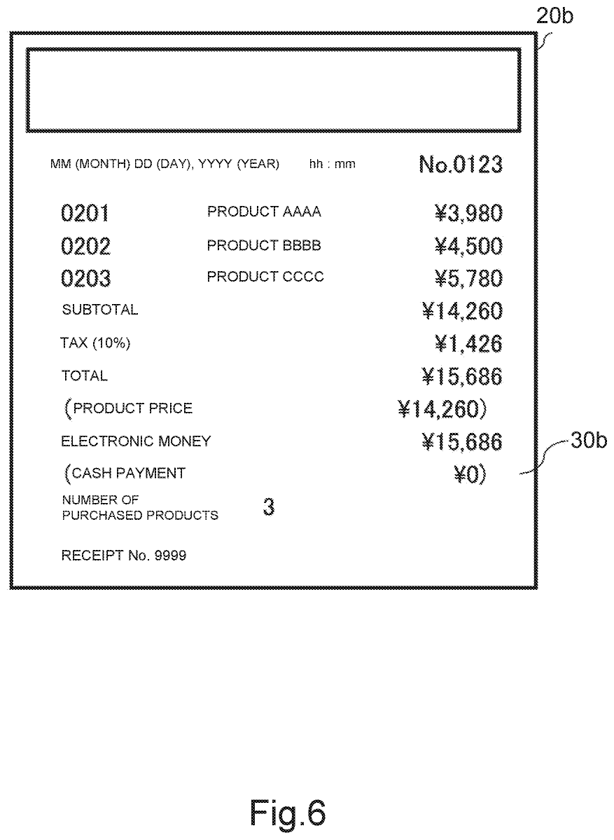

After the processing of ACT27 or ACT28, the processing of the processor 1 proceeds to ACT29. In ACT29, the processor 1 creates receipt data on the basis of the data of the transaction memory (main memory 2). The processor 1 then outputs the receipt data to the printer 9 and controls the printer 9 to print the receipt data on a receipt paper in ACT30. The printer 9 issues, for example, a receipt 20b described below shown in FIG. 6. Then, the processor 1 finishes the non-cash payment processing.

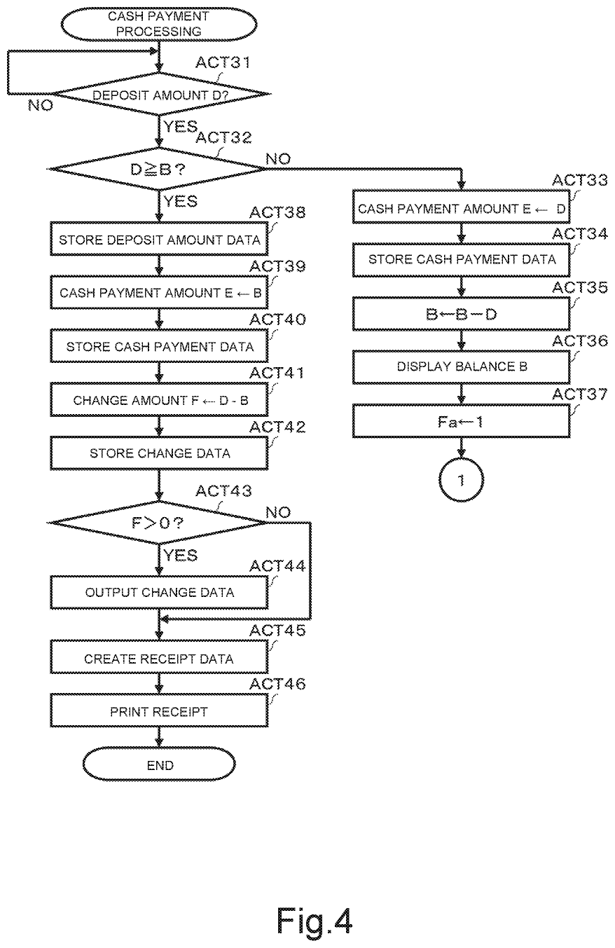

FIG. 4 is a flowchart showing the cash payment processing executed by the processor 1. When starting the cash payment processing, the processor 1 determines whether or not data of a deposit amount “D” has been acquired in ACT31. In the case where it is determined that the data of the deposit amount “D” put in the automatic change machine has been acquired via the change machine interface 11 (YES in ACT31), the processing of the processor 1 proceeds to ACT32. In ACT32, the processor 1 determines whether or not the deposit amount “D” is equal to or more than the balance “B”. The balance “B” (the value stored in the balance memory) in this case is the total amount “A” (see ACTT).

In the case where it is determined that the deposit amount “D” is less than the balance “B” (NO in ACT32), the payment of the price is not completed with the put cash. In this case, the processing of the processor 1 proceeds to ACT33. In ACT33, the processor 1 rewrites a cash payment amount “E” of the cash-payment-amount memory (the value stored in the cash-payment-amount memory) to the deposit amount “D”. The cash-payment-amount memory is formed in a volatile region of the main memory 2.

In ACT34, the processor 1 stores cash payment data. That is, the processor 1 writes cash payment data including a name code indicating cash payment and the cash payment amount “E” to the transaction memory (main memory 2). The processor 1 then subtracts the deposit amount “D” from the balance “B” of the balance memory (main memory 2) in ACT35. The balance “B” (the value stored in the balance memory) in this case is the total amount “A” (see ACTT). The processor 1 then displays the balance “B” on the display 8 in ACT36. That is, an amount obtained by subtracting the deposit amount “D” from the total amount “A” is displayed on the display 8.

In ACT37, the processor 1 sets the flag Fa to “1”. The processing of the processor 1 then returns to ACT8 in FIG. 2. That is, the processor 1 stands by for a payment method to be selected. When a payment method is selected, the processor 1 executes the processing of ACT9 and subsequent ACTs as described above.

Meanwhile, in the case where it is determined in ACT32 that the deposit amount D is equal to larger than the balance B, i.e., in the case where it is determined that the payment of the price has been completed (YES in ACT32), the processing of the processor 1 proceeds to ACT38. In ACT38, the processor 1 stores the deposit amount data. That is, the processor 1 writes the name code indicating the deposit amount and the deposit amount D to the transaction memory (main memory 2).

The processor 1 then rewrites the cash payment amount “E” of the cash-payment-amount memory (main memory 2) to the balance “B” In ACT39. The processor 1 then stores the cash payment data in ACT40. That is, the processor 1 writes the name code indicating cash payment and the cash payment amount “E” to the transaction memory (main memory 2).

The processor 1 then rewrites a change amount “F” of the change memory (the value stored in the change memory) to an amount obtained by subtracting the balance “B” from the deposit amount “D” in ACT41. The balance “B” (the value stored in the balance memory) in this case is the total amount “A” (see ACTT). Therefore, the change amount “F” of the change memory is written to the amount obtained by subtracting the total amount “A” from the deposit amount “D”. Note that the change memory is formed in a volatile region of the main memory 2. In ACT42, the processor 1 stores the change data. That is, the processor 1 writes the name code indicating the change and the change amount F to the transaction memory (main memory 2).

In ACT43, the processor 1 determines whether or not the change amount “F” is larger than 0 yen. In the case where it is determined that the change amount “F” is larger than 0 yen, i.e., in the case where it is determined that the change needs to be paid out (YES in ACT43), the processing of the processor 1 proceeds to ACT44. In ACT44, the processor 1 outputs change data to the automatic change machine via the change machine interface 11. The change data includes data of the change amount “F”. As a result, cash corresponding to the change amount “F” is paid out from the automatic change machine.

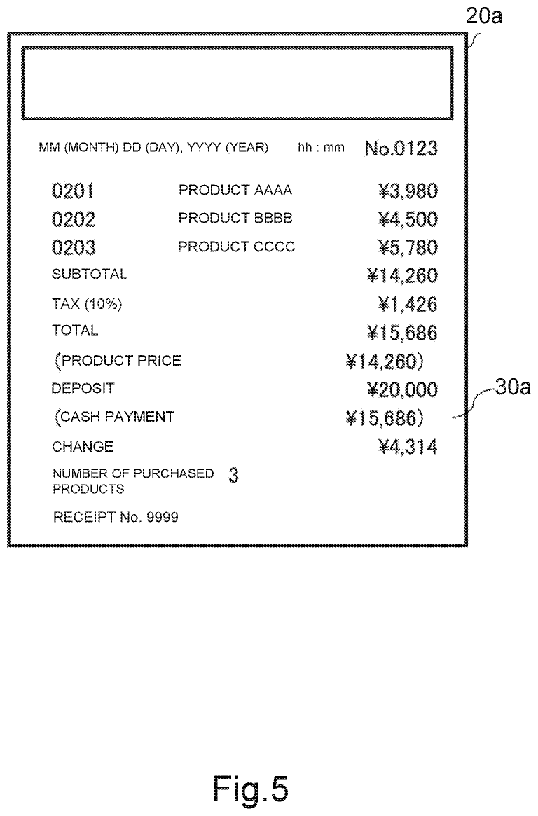

Meanwhile, in the case where it is determined that the change amount “F” is 0 yen (NO in ACT43), the processing of the processor 1 skips the processing of ACT44. When finishing or skipping the processing of ACT44, the processor creates receipt data on the basis of the data of the transaction memory (main memory 2) in ACT45. The processor 1 then outputs the receipt data to the printer 9 and controls the printer 9 to print the receipt data on a receipt paper in ACT46. The printer 9 issues, for example, a receipt 20a described below shown in FIG. 5. Then, the processor 1 finishes the cash payment processing.

Note that the processor 1 functions as a total acquisition unit by the processing of ACT6 in FIG. 2. That is, the processor 1 acquires the total amount “A” in a transaction. Further, the processor 1 functions as a payment acquisition unit by the processing of ACT8 to ACT12 in FIG. 2, the processing of ACT21 in FIG. 3, and the processing of ACT31 in FIG. 4. That is, the processor 1 acquires the payment amount “C” that is payment data for the total amount, or the deposit amount “D”.

The processor 1 functions as a cash payment acquisition unit by the processing of ACT34 and ACT39 in FIG. 4. That is, in the case where the deposit amount “D” of cash is included as the payment data, the processor 1 acquires the cash payment amount “E” used to pay the total amount “A”, of the deposit amount “D”.

The processor 1 functions as a creation unit by the processing of ACT45 in FIG. 4. That is, the processor 1 creates receipt data including information of the total amount “A” and the cash payment amount “E” as information regarding the transaction. Further, the processor 1 functions as a creation unit by the processing of ACT29 in FIG. 3. That is, in the case where the deposit amount “D” of cash is not included as the payment data, the processor 1 creates receipt data that includes information indicating that the cash payment amount is 0 yen.

The processor 1 functions as an output unit by the processing of ACT30 in FIG. 3 and ACT46 in FIG. 4. That is, the processor 1 outputs the receipt data to the printer 9.

FIG. 5 to FIG. 8 are each a schematic diagram showing an example of a receipt issued from the POS terminal according to this embodiment. In detail, a receipt issued to a consumer who has purchased a tax-exclusive product “AAAA” with a unit price of 3,980 yen, a tax-exclusive product “BBBB” with a unit price of 4,500 yen, and a tax-exclusive product “CCCC” with a unit price of 5,780 yen, will be exemplified. The tax rate added to each product is 10%. Therefore, the total amount is 15,686 yen.

FIG. 5 shows the receipt 20a in the case of payment by cash of 20,000 yen. As shown in the figure, the total amount of 15,686 yen and the product price of 14,260 yen followed by the deposit amount of 20,000 yen and the change amount of 4,314 yen are printed on the receipt 20a. Further, the cash payment amount of 15,686 yen is printed between the deposit amount and the change amount as indicated by a reference symbol 30a. The cash payment amount of 15,686 yen is printed in parentheses, and is printed separately from the deposit amount and the change amount. Therefore, it is easy for the consumer who has received the receipt 20a to know that the payment amount by cash is 15,686 yen. Moreover, since the cash payment amount is printed in parentheses, the consumer can recognize that the cash payment amount is ancillary information that is defined as part of the deposit amount.

FIG. 6 shows the receipt 20b in the case where the total amount is paid by electronic money. As shown in the figure, the total amount of 15,686 yen and the product price of 14,260 yen followed by the payment amount of 15,686 yen by electronic money are printed on the receipt 20b. Further, following the payment amount by electronic money, the cash payment amount of 0 yen is printed as indicated by a reference symbol 30b. The cash payment amount of 0 yen is printed in parentheses and is printed separately from the payment amount by electronic money. Therefore, a consumer who has received the receipt 20b can easily know that the payment amount by electronic money is 15,686 yen and that there is no payment amount by cash. Moreover, since the cash payment amount of 0 yen is printed in parentheses, the consumer can recognize that the cash payment amount is ancillary information unrelated to the transaction.

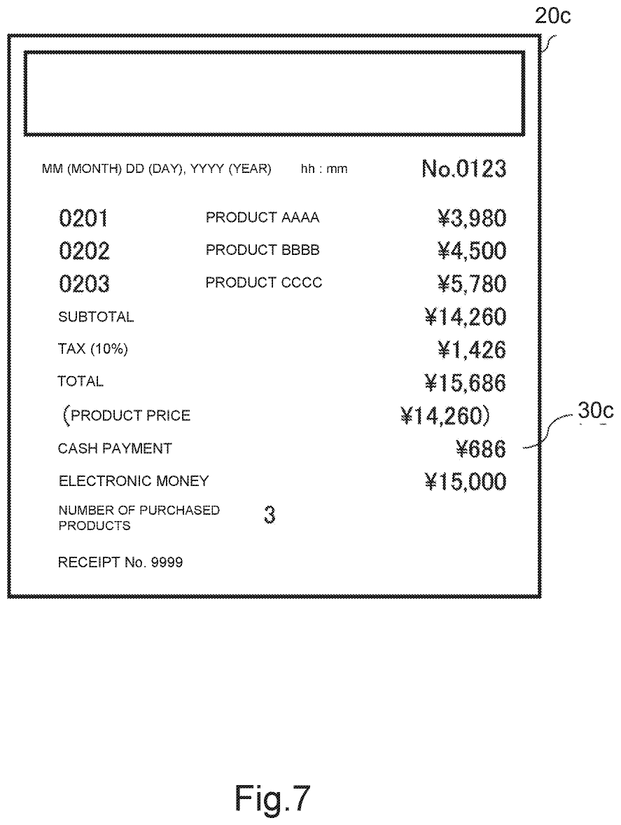

FIG. 7 shows a receipt 20c in the case where 686 yen out of the total amount of 15,686 yen is paid by cash and the remaining amount is paid by electronic money. As shown in the figure, the total amount of 15,686 yen and the product price of 14,260 yen followed by the payment amount of 686 yen by cash and the payment amount of 15,000 yen by electronic money are printed on the receipt 20c. In this case, as indicated by a reference symbol 30c, the payment amount of 686 yen by cash is not printed in parentheses. That is, the payment amount of 686 yen by cash is printed in the same form as that of the payment amount of 15,000 yen by electronic money. Therefore, a consumer who has received the receipt 20c can easily know that the payment amount by cash is 686 yen and the payment amount by electronic money is 15,000 yen.

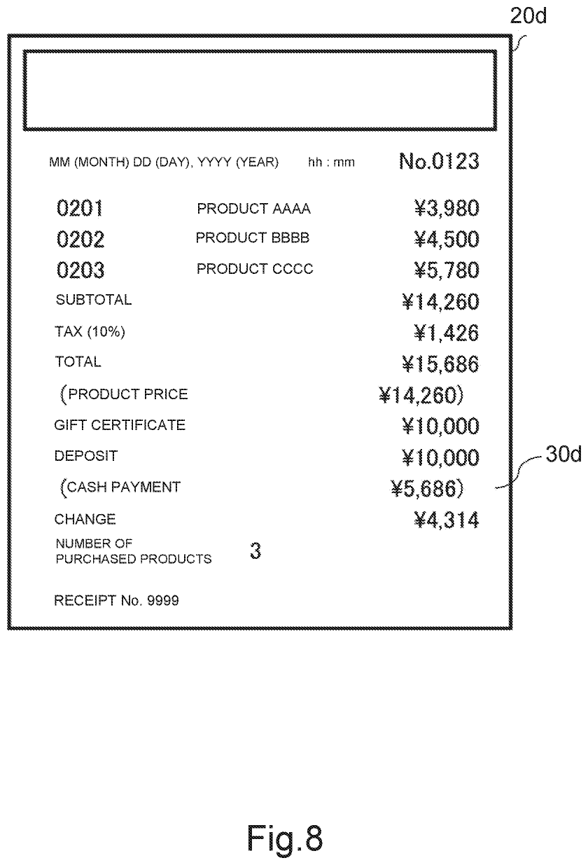

FIG. 8 shows a receipt 20d in the case where 10,000 yen out of the total amount of 15,686 yen is paid by a gift certificate, and the remaining amount is paid by cash 10,000 yen. As shown in the figure, the total amount of 15,686 yen and the product price of 14,260 yen followed by the payment amount of 10,000 yen by a gift certificate, the deposit amount of 10,000 yen, and the change amount of 4,314 yen are printed on the receipt 20d. Further, as indicated by a reference symbol 30d, the cash payment amount of 5,686 yen is printed between the deposit amount and the change amount. The cash payment amount of 5,686 yen is printed in parentheses and is printed separately from the payment amount by a gift certificate, the deposit amount, and the change amount. Therefore, a consumer who has received the receipt 20d can easily know that the payment amount by a gift certificate is 10,000 yen and the payment amount by cash is 5,686 yen. Moreover, since the cash payment amount is printed in parentheses, the consumer can recognize that the cash payment amount is ancillary information that is defined as part of the deposit amount.

As described above, in accordance with this embodiment, it is possible to provide a POS terminal capable of issuing a receipt from which the payment amount by cash can be easily grasped. Further, it is possible to provide a control program capable of causing a computer to function as a POS terminal capable of issuing a receipt from which the payment amount by cash can be easily grasped. Further, it is possible to provide a receipt data creation method of creating a receipt from which the payment amount by cash can be easily grasped.

Although an embodiment has been described above, the embodiment is not limited thereto. The above-mentioned embodiment has exemplified a case where receipt data is printed out by the printer 9. In this regard, the receipt data may be directly transmitted and output to a receipt server as electronic receipt data. In this case, a consumer can browse, by accessing the receipt server using a communication terminal such as a smartphone, the receipt image on a display of the communication terminal. Therefore, the consumer can easily know the payment amount by cash from the receipt image.

In ACT39 in FIG. 4 of the above-mentioned embodiment, the processor 1 has rewritten the cash payment amount “E” of the cash-payment-amount memory to the balance “B”. In this regard, the processor 1 may rewrite the cash payment amount “E” to the amount obtained by subtracting the change amount “F” from the deposit amount “D”.

In the above-mentioned embodiment has exemplified a case where receipt data including information indicating that the cash payment amount is 0 yen is created in the case where the deposit amount of cash is not included as the payment data. In this regard, the receipt data does not necessarily need to include information indicating that the cash payment amount is 0 yen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A payment apparatus, comprising:
an input device that inputs information regarding a product to be purchased by a customer in a transaction;
a transaction memory that stores information regarding the transaction;
an interface that communicates with a cash handling equipment;
a processor configured to
store product sales data in the transaction memory on a basis of the input information regarding the product,
acquire a total amount of the transaction on a basis of the product sales data stored in the transaction memory, and store total data including the acquired total amount in the transaction memory,
store, where a deposit amount of cash from a customer is acquired via the interface, deposit data including the deposit amount in the transaction memory,
acquire a payment amount to be paid by the customer for the total amount, and store payment data including the payment amount in the transaction memory,
acquire, where the deposit data is stored in the transaction memory, a cash payment amount used to pay the total amount, of the deposit amount included in the deposit data, and store cash payment data including the cash payment amount in the transaction memory,
create, on a basis of the information regarding the transaction stored in the transaction memory, receipt data including information regarding the total amount and the cash payment amount, and
output the created receipt data.

2. The payment apparatus according to claim 1, wherein
the processor creates the receipt data such that the receipt data including the information regarding the cash payment amount in a form different from that of the information regarding the total amount is output.

3. The payment apparatus according to claim 2, further comprising
a printer that prints, on a basis of the receipt data, the information regarding the transaction on a receipt paper to issue a receipt, wherein
the processor creates the receipt data such that a receipt in which the information regarding the cash payment amount and the information regarding the total amount are printed in different forms is issued by a printer, and outputs the created receipt data to the printer.

4. The payment apparatus according to claim 2, wherein
the processor
determines, where the deposit data is stored in the transaction memory, whether or not payment for the total amount is completed, and
creates, where it is determined that the payment for the total amount is completed, the receipt data such that the receipt data including the information regarding the cash payment amount in a form different from that of the information regarding the total amount is output.

5. The payment apparatus according to claim 2, wherein
the processor creates, where it is determined that payment for the total amount is not completed, the receipt data such that the receipt data including the information regarding the cash payment amount in a form that is the same as that of the information regarding the total amount is output.

6. The payment apparatus according to claim 1, wherein
the processor creates, where the deposit data is not stored in the transaction memory, receipt data including information indicating that the cash payment amount is not included.

7. The payment apparatus according to claim 1, wherein
the processor
determines a payment method of a customer for the total amount,
determines, where it is determined that the payment method of a customer is payment by cash, whether or not the deposit amount of cash from the customer is acquired via the interface, and
stores, where it is determined that the deposit amount of cash from the customer is acquired, the deposit data including the deposit amount in the transaction memory.

8. The payment apparatus according to claim 7, wherein
the processor acquires, where it is determined that the payment method of a customer is payment by a payment method other than cash, a payment amount to be paid by the customer for the total amount, and stores the payment data including the payment amount in the transaction memory.

9. The payment apparatus according to claim 7, wherein
the processor
determines, where the deposit data is stored in the transaction memory, whether or not payment for the total amount is completed, and
determines, where it is determined that the payment for the total amount is not completed, the payment method of the customer again for a difference between the total amount and the deposit amount.

10. A receipt data creation method for a payment apparatus that includes an input device that inputs information regarding a product to be purchased by a customer in a transaction, a transaction memory that stores information regarding the transaction, and an interface that communicates with a cash handling equipment, comprising:
storing product sales data in the transaction memory on a basis of the information regarding the product input by the input device;
acquiring a total amount of the transaction on a basis of the product sales data stored in the transaction memory, and storing total data including the acquired total amount in the transaction memory;
storing, where a deposit amount of cash from a customer is acquired via the interface, deposit data including the deposit amount in the transaction memory;
acquiring a payment amount to be paid by the customer for the total amount, and storing payment data including the payment amount in the transaction memory;
acquiring, where the deposit data is stored in the transaction memory, a cash payment amount used to pay the total amount, of the deposit amount included in the deposit data, and storing cash payment data including the cash payment amount in the transaction memory;
creating, on a basis of the information regarding the transaction stored in the transaction memory, receipt data including information regarding the total amount and the cash payment amount; and
outputting the created receipt data.
